(19) United States
(12) Patent Application Publication
(10) Pub. No.: US 2009/0150495 A1
(43) Pub. Date: Jun. 11, 2009

(54) Chain-Scoped Dynamic Electronic Mail System and Method

(76) Inventors: Qian Sun, Rochester, MN (US); Jian Tang, Rochester, MN (US); Xiaoming Yu, Rochester, MN (US); Jingli Zhang, Rochester, MN (US)

Correspondence Address: IBM-Rochester c/o Toler Law Group, 8500 Bluffstone Cove, Suite A201, Austin, TX, 78759, US

(21) Appl. No.: 11/951,482

(22) Filed: Dec. 6, 2007

(51) Int. Cl. G06F 15/16

(52) U.S. Cl. 709/206

(57) ABSTRACT

A method, system and program product allow an originator of an electronic mail message to create and attach different topics to messages. Recipients of messages can view different topics from an electronic mail message and can take actions on specific topics and related content. Electronic mail messages can be organized based on topics. Each topic in a string of electronic mail messages is chain-scoped with its lifetime bounded by an electronic mail chain.

### FIELD OF THE INVENTION

The present invention relates generally to computing devices and systems, and more particularly, to electronic mail messages.

### BACKGROUND OF THE INVENTION

Electronic mail transport remains one of the prominent uses of networking. Electronic mail started as a simple service that copied a file from one machine to another and appended it to a recipient's mailbox. Various standards of electronic mail exchange have been devised, with sites on the Internet adhering to specific standards to provide a machine-independent way of transferring just about anything, including graphics, sound files, and special characters.

In a simple configuration, an Internet service provider is typically connected to the Internet. Multiple users having terminals subscribe to a service provided by the Internet service provider, and electronic mail is routed through a programmed server from one user to another.

While this describes the simplest form of routing electronic mail messages, there are alternative and sometimes more complex configurations. For example, a large enterprise may have a server connected to the Internet, which may connect to various individual terminals within the enterprise, such as in a corporate environment. Such conventional systems have been implemented on a world-wide basis for quite some time, facilitating communication between individuals.

An electronic mail message generally consists of a message body, which is the text of the message, and special administrative data. The administrative data may specify recipients, transport medium, etc., much like what you see when you look at the envelope of a physical letter. Administrative data falls into two categories. A first category is data specific to the transport medium, like the address of sender and recipient. This first category is called the envelope. The second type of data is data necessary for handling the mail message. Such data may include the message's subject line, a list of all recipients, and the date the message was sent. In many networks, it has become standard to prepend this data to the mail message, forming the mail header.

An electronic mail message also has pre-defined attributes. Such attributes include but are not limited to, addressee lists such as “sender,” “to,” “cc” and “bcc” lists, a subject, signature, content, etc. Existing electronic mail systems provide a variety of ways to organize electronic mail messages based on these attributes. For example, electronic mail messages may be categorized by the sender, subject, or other attributes selected by a user.

In present electronic mail systems, there is usually only one subject line. However, since electronic mail is text written by people in natural language, there is no guarantee that the content reflects only one subject. In most cases, electronic mail conveys multiple subjects or topics, and in many cases the sender expects the recipients to read all the topics and take different courses of action. Accordingly, a single “subject” for one electronic mail message is often insufficient for most cases of electronic mail communications. For example, an electronic mail communication relating to an upcoming picnic may contain multiple topics such as “picnic details,” “RSVP request,” and “volunteer sign-up actions.” Thus, using only the subject, or topic, “picnic” does not fully represent the contents of the electronic mail communication.

Other current electronic mail systems include certain features allowing users to define labels for electronic mail communications. For example, Gmail and other electronic mail systems have the capability of defining labels, but the label is defined and attached to electronic mail communications by recipients, and is defined globally.

Certain other electronic mail tools enable a user to characterize and filter electronic mail messages before downloading to a user's electronic mail program. The electronic mail may be organized by size, attachment, foreign language characters, and several other criteria. In addition, custom filters may be created based on common message properties like sender, subject, etc. However, this systems method is a passive way to manage electronic mail messages and is limited in flexibility and character.

Another prior art electronic mail classifier provides users the ability to efficiently and easily assign category information to messages. A graphical window may be presented to a user interacting with the message. Through the graphical window, the user enters information describing at least one category to which the electronic mail communication relates. The electronic mail message and its associated category information may be archived for later access.

Another conventional provides a user interface which uses electronic mail tags to permit a user to view an electronic mail family in a graphical manner illustrating the relationship among electronic mail messages in that family.

All of these prior art systems suffer in that they fail to allow a user to manage mail dynamically, with flexibility and clarity in relationship to natural language that is used when composing messages. For at least these reasons, there exists a need for an improved method and system for configuring and managing electronic mail communications, thereby enhancing readability, flexibility and tractability.

### SUMMARY OF THE INVENTION

The present invention provides an improved computer implemented method, apparatus and program product for dynamically structuring and organizing electronic mail messages. Aspects of the invention may include composing an electronic mail message. Topics that are the subject of the electronic mail message may be defined. The defined topics may be correlated with respective content portions of the electronic mail message. The configured message may then be transmitted through a network, such as the Internet, to at least one recipient on the network. The recipient, while having the capability to configure and send electronic messages as previously described, may also read the entire received electronic mail message through its topic chain, respond to at least one topic in the electronic mail message, respond to the electronic mail message as if there were no topics, or respond to the electronic mail message by adding or removing topics.

An apparatus is also provided that includes at least a first computer configured for sending and receiving electronic mail messages through a network. A processor and memory on the first computer are configured for allowing composing of electronic mail messages, defining topics which are the subject of the electronic mail message, and correlating the defined topics with respective content in the electronic mail message for display as part of the message. The apparatus is further configured for transmitting the electronic message through a network to at least one recipient. A recipient computer may be configured as previously described, and further configured for receiving electronic mail messages and having content of received electronic mail messages correlated with topics corresponding to the content thereof.

In yet another aspect, a program product includes program code configured for composing electronic mail messages and defining topics that are the subject of the electronic mail message. The program code may be further configured for correlating the defined topics with respective content of the electronic message and for replying to electronic mail messages classified by content. A computer readable medium may bear the program code.

These and other advantages and features that characterize the invention are set forth in the claims annexed hereto and forming a further part hereof. However, for a better understanding of the invention, and of the advantages and objects attained through its use, reference should be made to the Drawings, and to the accompanying descriptive matter, in which there are described exemplary embodiments of the invention.

### BRIEF DESCRIPTION OF THE DRAWINGS

FIG. 1 is a schematic diagram illustrating a network, such as the Internet, servers and terminals connected thereto, capable of implementing an electronic mail messaging system;

FIG. 2 illustrates a typical electronic mail message configured using conventional electronic mail systems providing only one subject line;

FIG. 3 is an exemplary electronic mail message classified by multiple topics in accordance with aspects of the invention;

FIG. 4 is a flow diagram illustrating how an electronic mail tree may be organized under topics in accordance with the invention;

FIG. 5 is a flow diagram illustrating various options or actions by a recipient receiving an electronic mail message classified by topics in accordance with the invention; and

FIG. 6 is a diagram illustrating a tree structure showing an electronic mail chain between an original sender and two recipients.

### DETAILED DESCRIPTION OF THE PREFERRED EMBODIMENTS

Embodiments consistent with the underlying principles of the present invention may optimize electronic mail communication by dynamically allowing a sender and recipient to create and attach different topics (sub-subjects) to electronic mail communications. In this manner, aspects of the invention may offer a more efficient way to structure and organize electronic mail communications. Recipients may view different topics from the electronic mail communication, for example, using one of many conventional user interface tools. Recipients may take actions related to specific topics and associated content. In addition, both senders and recipients may organize electronic mail communications based on selected topics, or may view a response tree for a particular topic in an electronic mail chain.

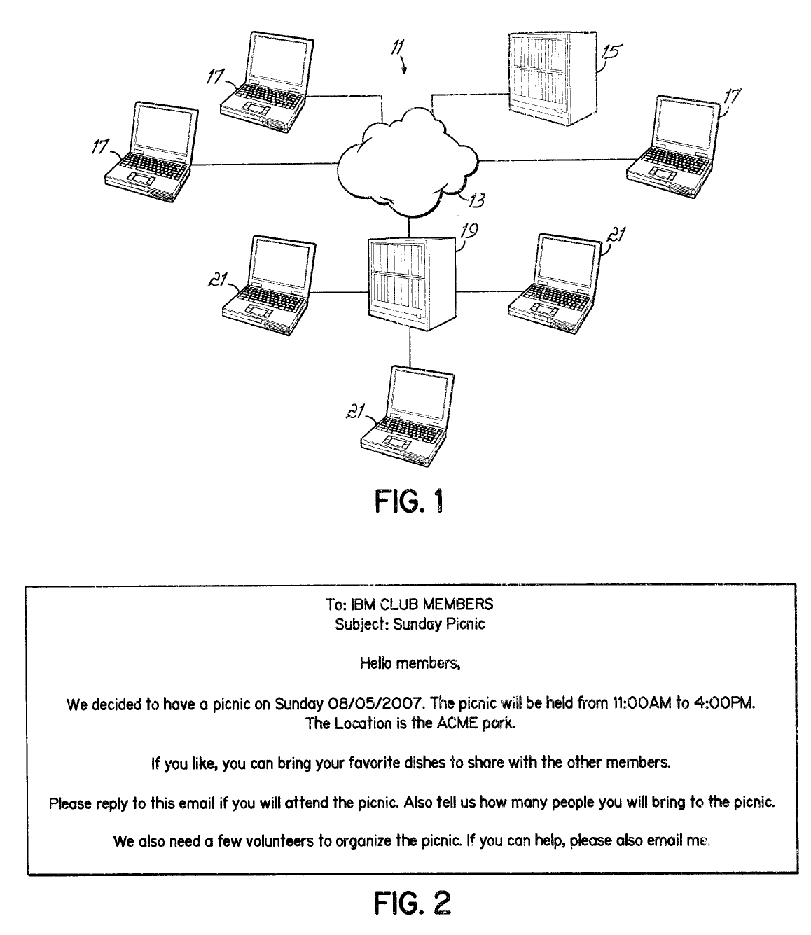

FIG. 1 illustrates generally a network within which features of the invention may be implemented. Such a network 11 may be the Internet, and includes network interconnections 13. At least one server 15 may function as an Internet service provider also providing users 17 with electronic mail messaging services through the network 11. While individual users 17 may subscribe to the network server 15 service provider, it is also possible that other types of servers 19, such as are found in a corporate enterprise with individual users 21 connected thereto, may be implemented in such a system.

In accordance with aspects of the invention, programming for electronic mail messaging systems may be provided in numerous locations, including an individual user terminal or through an Internet service provider. More specifically, in accordance with aspects of the invention a sender may dynamically define topics in an electronic mail message. When recipients reply to such an electronic mail message, topics can be added, modified or deleted. The topics are chain-scoped, so that for each topic its lifetime is bounded by the electronic mail chain. Each topic has a specific meaning for a particular electronic mail chain. Thus, the same topic name in different electronic mail chains may have different meanings. This is different from pre-defined labels as employed in the prior art, where one label represents one specific meaning for all electronic mail messages in an inbox.

Thus, better readability is provided. More specifically, since the electronic mail message is organized into different topics, it is easy to identify how many topics the message conveys and the topic boundaries. Further, users are less likely to miss specific topics in a message.

In addition, content selectivity is provided. Users can choose specific topics to read if they are only interested in specific parts of a message. Moreover, users may more easily identify the topics with greater urgency, such as actions required. Increased flexibility is provided by allowing users to view and respond to specific topics. In so doing, other topics may be removed in the subsequent electronic mail exchanges, thereby enhancing readability. Flexibility is further enhanced. In an electronic mail chain, which consists of a series of responses to an electronic message, users may use tools such as a user interface tool, to display responses to specific topics in a flat-tree structure. This provides users with topic flexibility so that they can observe who responded to a specific topic.

FIG. 2 illustrates a conventional electronic mail message in exemplary form. The message contains three topics: picnic information, RSVP requests, and volunteering. In the illustrated conventional email message, it is possible that a recipient will miss one or more topics.

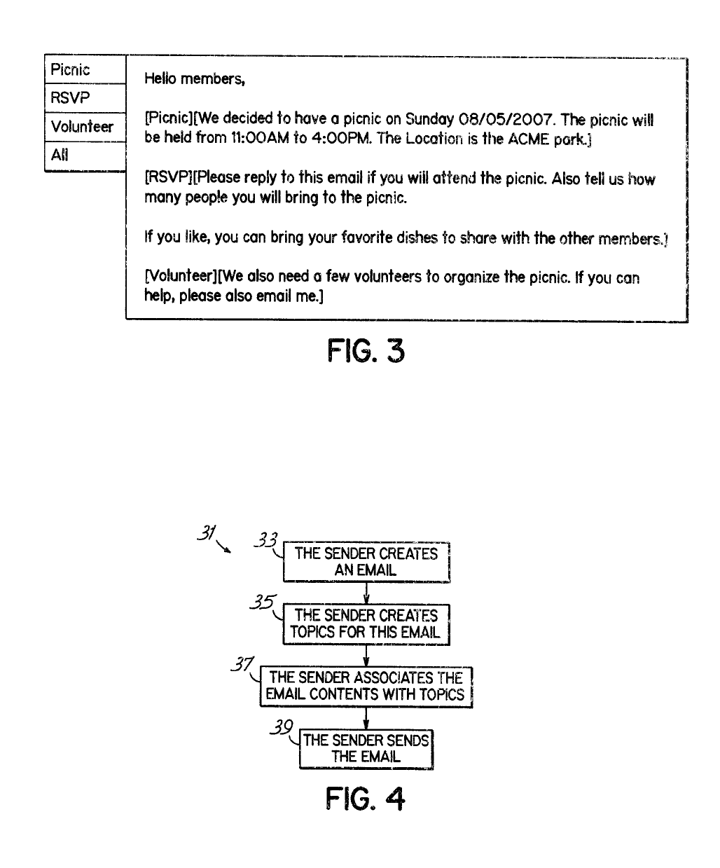

In accordance with the invention, readability may be greatly enhanced. More specifically, using a Graphical User Interface (GUI) tool, a sender may define topics when composing an electronic mail. Accordingly, when transformed in accordance with the method, system and product of the invention, the electronic mail message may be reconfigured as shown in FIG. 3. The topics may be displayed on the side of the message. FIG. 3 also shows that when using an appropriate GUI tool, which is conventional and readily known to those of ordinary skill in the art, the electronic mail message contents can be displayed in their entirety, or selectively for a particular topic. Recipients may choose to reply to one topic by clicking on the topic link, or may reply to multiple topics. After receiving responses, the electronic message originator may simply look at a particular topic of interest to see who among the recipients is interested in a particular topic.

Implementation of the method, system and product of the invention may involve defining topics and associating them with content in electronic mail messages. The electronic mail message may allow a sender of messages to define topics dynamically and associate them with content contained in the method. This is possible in a number of different ways. For example, a User Interface (UI) tool, of the type well-known to those of ordinary skill in the art, can allow a user to create a topic and select the electronic mail message part to associate with that topic. In implementing the system, the electronic mail format is slightly modified to accommodate the topics associated with the message. This can be achieved in several ways, such as XML or annotation.

On the recipient end, it is important to be able to view topics with the electronic message. Once an electronic message arrives, a recipient may view the topics with the electronic mail message. This can be done in many different ways, for example, by using a UI tool, similar in nature to the one used to create topics and associate content with the topic.

Finally, it is important to be able to organize an electronic mail chain using topics. This is possible by parsing the electronic mail in the native format. Thus, if XML is used, all the matched electronic mail topics may be found and organized in a tree based on the response relationship. The electronic mail response relationship may be a tuple containing original messages, response messages, and responder identification.

FIG. 4 illustrates how a sender creates an email. Flow diagram 31 includes a first step 33 where the sender creates an electronic message. Thereafter, the sender creates topics for the electronic mail message 35. The topics of the electronic mail message are associated with respective content within the message 37. The sender then sends the electronic mail message to one or more recipients 39.

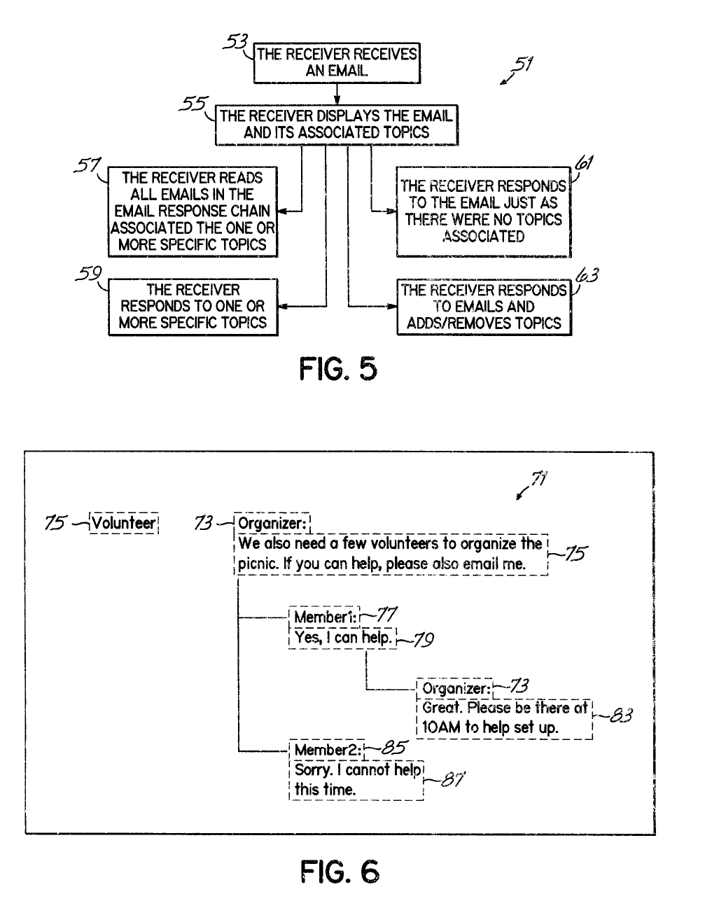

FIG. 5 illustrates an electronic mail message tree organized under one or more topics. In the diagram 51, a recipient receives an electronic mail message 53. The recipient displays the electronic mail message, along with its associated topics 55. Thereafter, the recipient has several options. A first option involves reading all of the electronic mail messages in the electronic mail response chain associated with one or more specific topics 57. The recipient can also respond to one or more specific topics 59. Alternatively, the recipient may respond to the electronic mail message just as if there were no topics associated 61. Finally, the recipient may respond to the electronic mail message(s) and add or remove topics 63.

FIG. 6 is a tree structure of an original electronic mail message from an “organizer.” Two recipients reply to the original message. The organizer replies back to one recipient of the original message. More specifically, the tree 71 shows an original electronic mail message 75 to multiple recipients from an organizer 73 that is requesting volunteers, and identifying the content of the message with a topic 75. A first recipient, or member 77, replies with a message 79 indicating that the member 77 can help. The organizer 73 then replies to the first member's 77 message 79 with a further reply 83. A second member 85 replies with a message 87 indicating that help could not be provided at this time.

While the present invention has been illustrated by a description of various embodiments and while these embodiments have been described in considerable detail, it is not the intention of the Applicants to restrict, or any way limit, the scope of the appended claims to such detail. For instance, while some of the embodiments described herein may lend themselves particularly well to hardware implementations, alternative embodiments may be realized in software, and/or may encompass other electronic mail practices. Similarly, embodiments of the invention may be realized in different implementations of programming among a multitude of machines and systems. The invention in its broader aspects is therefore not limited to the specific details, representative apparatus, method and product, and illustrative example shown and described. Accordingly, departures may be made from such details without departing from the spirit or scope of Applicants' general inventive concept.

What is claimed is:

1. A computer implemented method of dynamically structuring and organizing electronic mail messages, the method comprising:
composing an electronic mail message;
defining topics that are the subject of the electronic mail message; and
correlating said defined topics with respective contents of said electronic mail message.

2. The method of claim 1, further comprising transmitting said electronic mail message through a network to at least one recipient computer on the network.

3. The method of claim 2, further comprising receiving the electronic mail message at the recipient computer.

4. The method of claim 1, wherein said electronic message is configured for having a topic identifier displayed adjacent content related thereto.

5. The method of claim 3, further comprising at least one of: reading the entire received electronic mail message for a topic chain; responding to at least one topic in the electronic mail message; responding to the electronic mail message as if there were no topics associated with the content; and responding to the electronic mail message by adding or removing topics.

6. The method of claim 5, wherein each topic is chain-scoped through an electronic mail chain created by senders of electronic mail messages and by recipients.

7. The method of claim 5, further comprising viewing a response tree for a particular topic in an electronic mail chain of messages.

8. The method of claim 7, further comprising displaying responses to a specific topic in a flat-tree structure.

9. An apparatus, comprising:
a first computer configured for sending and receiving electronic messages through a network; and
a processor and memory in said first computer configured for allowing composing of electronic mail messages, defining topics that are the subject of electronic mail messages, and correlating said defined topics with respective contents of the electronic mail messages for display as part of each message.

10. The apparatus of claim 9, further comprising said processor and memory configured for transmitting said electronic message through a network to at least one recipient computer on the network.

11. The network of claim 10, wherein said processor and memory are further configured for receiving electronic mail messages having the contents of received electronic mail messages correlated with displayed topics corresponding thereto.

12. The apparatus of claim 10, further comprising:
at least one other computer on a network connected for receiving electronic mail messages from said first computer, said at least one other computer configured for sending and receiving electronic messages through said network; and
a processor and memory in said at least one other computer configured for receiving electronic message classified by topic from said first computer, and for replying thereto.

13. The apparatus of claim 12, wherein said at least one other computer is further configured for replying by topic to electronic messages classified by topic.

14. The apparatus of claim 9, wherein said first computer processor and memory are further configured for receiving electronic mail messages correlated with topics corresponding to content thereof, and for replying thereto by topic.

15. The apparatus of claim 13, wherein said at least one other computer processor and memory are configured for allowing composing of electronic mail messages, defining topics that are the subject of electronic mail messages, and correlating said defined topics with respective content portions of the electronic mail messages for display as part of the message.

16. The apparatus of claim 15, wherein said processor and memory are further configured for at least one of reading an entire electronic mail message classified by topic; responding to at least one topic in an electronic mail message classified by topic; responding to an electronic mail message classified by topic as if there were no topics; and responding to the electronic mail message by adding or removing topics.

17. The apparatus of claim 14, wherein said processor and memory are further configured for at least one of reading an entire electronic mail message classified by topic; responding to at least one topic in an electronic mail message classified by topic; responding to an electronic mail message classified by topic as if there were no topics; and responding to the electronic mail message by adding or removing topics.

18. The apparatus of claim 9, further configured for arranging a string of electronic mail messages as an electronic mail chain by topic.

19. The apparatus of claim 18, further configured to view a response tree on a display for a particular topic in an electronic mail chain of messages.

20. A program product, comprising:
program code configured for composing an electronic mail message, defining topics that are the subject of the electronic mail message, correlating said defined topics with respective contents of the electronic mail message, and replying to electronic mail message classified by content; and
a computer readable medium bearing the program code.
